(19) United States
(12) Patent Application Publication
(10) Pub. No.: US 2021/0089913 A1
(43) Pub. Date: Mar. 25, 2021

(54) INFORMATION PROCESSING METHOD AND APPARATUS, AND STORAGE MEDIUM

(71) Applicant: SHENZHEN SENSETIME TECHNOLOGY CO., LTD., Shenzhen (CN)

(72) Inventors: Zhaoyang ZHANG, Shenzhen (CN); Lingyun WU, Shenzhen (CN); Ping LUO, Shenzhen (CN)

(73) Assignee: SHENZHEN SENSETIME TECHNOLOGY CO., LTD., Shenzhen (CN)

(21) Appl. No.: 17/110,202

(22) Filed: Dec. 2, 2020

Related U.S. Application Data
(63) Continuation of application No. PCT/CN2019/114448, filed on Oct. 30, 2019.

(30) Foreign Application Priority Data
May 21, 2019 (CN) 201910425613.2

(51) Int. Cl. G06N 3/08; G06N 3/04

(52) U.S. Cl. CPC G06N 3/08; G06N 3/04

(57) ABSTRACT

The present disclosure relates to an information processing method and apparatus, an electronic device, and a storage medium. The method includes: inputting received input information into a neural network; processing the input information by means of the neural network, where in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and outputting a processing result of the processing of the neural network. According to embodiments of the present disclosure, group convolution of a neural network in any form can be implemented.

### CROSS-REFERENCE TO RELATED APPLICATIONS

This present application is a bypass continuation of and claims priority under 35 U.S.C. § 111(a) to PCT Application. No. PCT/CN2019/114448, filed on Oct. 30, 2019, which claims priority to Chinese Patent Application No. 201910425613.2, filed to the Chinese Intellectual Property Office on May 21, 2019 and entitled “INFORMATION PROCESSING METHOD AND APPARATUS, ELECTRONIC DEVICE, AND STORAGE MEDIUM”, each of which is incorporated herein by reference in its entirety.

### TECHNICAL FIELD

The present disclosure relates to the field of information processing, and in particular, to an information processing method and apparatus, an electronic device, and a storage medium.

### BACKGROUND

With the help of powerful performance advantages, a convolutional neural network promotes significant progress in the fields of computer vision, natural language processing, etc., and becomes a research upsurge in industry and academia. However, because a deep convolutional neural network is limited by a large number of matrix operations, massive storage and computing resources are often required. Reducing the redundancy of a convolution unit in the neural network is one of the important ways to solve this problem. Group convolution is a mode of channel group convolution and is widely applied to various networks.

### SUMMARY

The present disclosure provides the technical solution of executing information processing of input information by means of a neural network.

According to one aspect of the present disclosure, an information processing method is provided, applied to a neural network and including:

inputting received input information into a neural network;

processing the input information by means of the neural network, where in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and

outputting a processing result of the processing of the neural network.

In some possible implementations, updating the convolution kernel of the convolution layer by using the transformation matrix configured for the convolution layer includes:

acquiring a space dimension of the convolution kernel of the convolution layer;

executing duplication processing on the transformation matrix corresponding to the convolution layer based on the space dimension of the convolution kernel, where the number of times of duplication processing is determined by the space dimension of the convolution kernel; and

executing dot product processing on the transformation matrix after the duplication processing and the convolution kernel to obtain the updated convolution kernel of the corresponding convolution layer.

In some possible implementations, before executing convolution processing by means of the convolution layer of the neural network, the method further includes:

determining a matrix unit constituting the transformation matrix corresponding to the convolution layer, where the matrix unit includes a first matrix and a second matrix, or only includes the second matrix, where in response to the number of channels of an input feature and the number of channels of an output feature of the convolution layer being different, the transformation matrix corresponding to the convolution layer includes the first matrix and the second matrix; and in response to the number of channels of the input feature and the number of channels of the output feature of the convolution layer being identical, the transformation matrix corresponding to the convolution layer includes the second matrix, where the first matrix is formed by connecting unit matrixes, and the second matrix is obtained by inner products of function transformations of a plurality of sub-matrixes; and

forming the transformation matrix of the convolution layer based on the determined matrix unit.

In some possible implementations, determining the second matrix constituting the transformation matrix of the convolution layer includes:

acquiring a gate control parameter configured for each convolution layer;

determining the sub-matrixes constituting the second matrix based on the gate control parameter; and

forming the second matrix based on the determined sub-matrixes.

In some possible implementations, acquiring the gate control parameter configured for each convolution layer includes:

acquiring the gate control parameter configured for each convolution layer according to received configuration information; or

determining the gate control parameter configured for the convolution layer based on a training result of the neural network.

In some possible implementations, forming the transformation matrix of the convolution layer based on the determined matrix unit includes:

acquiring the number of first channels of the input feature and the number of second channels of the output feature of each convolution layer;

in response to the number of the first channels being greater than the number of the second channels, forming the transformation matrix as a product of the first matrix and the second matrix; and

in response to the number of the first channels being less than the number of the second channels, forming the transformation matrix as a product of the second matrix and the first matrix.

In some possible implementations, determining the sub-matrixes constituting the second matrix based on the gate control parameter includes:

performing function processing on the gate control parameter by using a sign function to obtain a binaryzation vector; and

obtaining a binaryzation gate control vector based on the binaryzation vector, and obtaining the plurality of sub-matrixes based on the binaryzation gate control vector, a first basic matrix, and a second basic matrix.

In some possible implementations, obtaining the binaryzation gate control vector based on the binaryzation vector includes:

determining the binaryzation vector as the binaryzation gate control vector; or

determining a product of a permutation matrix and the binaryzation vector as the binaryzation gate control vector.

In some possible implementations, obtaining the plurality of sub-matrixes based on the binaryzation gate control vector, the first basic matrix, and the second basic matrix includes:

in response to an element in the binaryzation gate control vector being a first numerical value, obtaining a sub-matrix of an all-ones matrix; and

in response to the element in the binaryzation gate control vector being a second numerical value, obtaining a sub-matrix of the unit matrix.

In some possible implementations, the first basic matrix is the all-ones matrix, and the second basic matrix is the unit matrix.

In some possible implementations, forming the second matrix based on the determined sub-matrixes includes:

performing an inner product operation on the plurality of sub-matrixes to obtain the second matrix.

In some possible implementations, the input information includes at least one of text information, image information, video information, or voice information.

In some possible implementations, the dimension of the transformation matrix is a product of the number of the first channels and the number of the second channels, the number of the first channels is the number of channels of the input feature of the convolution layer, the number of the second channels is the number of channels of the output feature of the convolution layer, and an element of the transformation matrix includes at least one of 0 or 1.

In some possible implementations, the method further includes a step of training the neural network, which includes:

acquiring a training sample and a real detection result for monitoring;

performing processing on the training sample by using the neural network to obtain a prediction result; and

feeding back and adjusting a network parameter of the neural network based on a loss corresponding to the prediction result and the real detection result, until a termination condition is satisfied, where the network parameter includes the convolution kernel of each network layer and the transformation matrix.

According to the second aspect of the present disclosure, an information processing apparatus is provided, including:

an input module configured to input received input information to a neural network;

an information processing module configured to process the input information by means of the neural network, where in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and

an output module configured to output a processing result of the processing of the neural network.

In some possible implementations, the information processing module is further configured to: acquire a space dimension of the convolution kernel of the convolution layer;

execute duplication processing on the transformation matrix corresponding to the convolution layer based on the space dimension of the convolution kernel, where the number of times of duplication processing is determined by the space dimension of the convolution kernel; and

execute dot product processing on the transformation matrix after the duplication processing and the convolution kernel to obtain the updated convolution kernel of the corresponding convolution layer.

In some possible implementations, the information processing module is further configured to determine a matrix unit constituting the transformation matrix corresponding to the convolution layer, and form the transformation matrix of the convolution layer based on the determined matrix unit, where the matrix unit includes a first matrix and a second matrix, or only includes the second matrix, where in response to the number of channels of an input feature and the number of channels of an output feature of the convolution layer being different, the transformation matrix corresponding to the convolution layer includes the first matrix and the second matrix; and in response to the number of channels of the input feature and the number of channels of the output feature of the convolution layer being identical, the transformation matrix corresponding to the convolution layer includes the second matrix, where the first matrix is formed by connecting unit matrixes, and the second matrix is obtained by inner products of function transformations of a plurality of sub-matrixes.

In some possible implementations, the information processing module is further configured to acquire a gate control parameter configured for each convolution layer;

determine the sub-matrixes constituting the second matrix based on the gate control parameter; and

form the second matrix based on the determined sub-matrixes.

In some possible implementations, the information processing module is further configured to acquire the gate control parameter configured for each convolution layer according to received configuration information; or

determine the gate control parameter configured for the convolution layer based on a training result of the neural network.

In some possible implementations, the information processing module is further configured to acquire the number of first channels of the input feature and the number of second channels of the output feature of each convolution layer;

in response to the number of the first channels being greater than the number of the second channels, form the transformation matrix as a product of the first matrix and the second matrix; and

in response to the number of the first channels being less than the number of the second channels, form the transformation matrix as a product of the second matrix and the first matrix.

In some possible implementations, the information processing module is further configured to perform function processing on the gate control parameter by using a sign function to obtain a binaryzation vector; and

obtain a binaryzation gate control vector based on the binaryzation vector, and obtain the plurality of sub-matrixes based on the binaryzation gate control vector, a first basic matrix, and a second basic matrix.

In some possible implementations, the information processing module is further configured to determine the binaryzation vector as the binaryzation gate control vector; or

determine a product of a permutation matrix and the binaryzation vector as the binaryzation gate control vector.

In some possible implementations, the information processing module is further configured to obtain a sub-matrix of an all-ones matrix in the case that an element in the binaryzation gate control vector is a first numerical value; and

obtain a sub-matrix of the unit matrix in the case that an element in the binaryzation gate control vector is a second numerical value.

In some possible implementations, the first basic matrix is the all-ones matrix, and the second basic matrix is the unit matrix.

In some possible implementations, the information processing module is further configured to perform an inner product operation on the plurality of sub-matrixes to obtain the second matrix.

In some possible implementations, the input information includes at least one of text information, image information, video information, or voice information.

In some possible implementations, the dimension of the transformation matrix is a product of the number of the first channels and the number of the second channels, the number of the first channels is the number of channels of the input feature of the convolution layer, the number of the second channels is the number of channels of the output feature of the convolution layer, and an element of the transformation matrix includes at least one of 0 or 1.

In some possible implementations, the information processing module is further configured to train the neural network, where the step of training the neural network includes:

acquiring a training sample and a real detection result for monitoring;

performing processing on the training sample by using the neural network to obtain a prediction result; and

feeding back and adjusting a network parameter of the neural network based on a loss corresponding to the prediction result and the real detection result, until a termination condition is satisfied, where the network parameter includes the convolution kernel of each network layer and the transformation matrix.

According to the third aspect of the present disclosure, an electronic device is provided, including: a processor; and a memory configured to store processor-executable instructions; where the processor is configured to call the instructions stored in the memory, so as to execute the method according to any one in the first aspect.

According to the fourth aspect of the present disclosure, a computer-readable storage medium is provided, having computer program instructions stored thereon, where when the computer program instructions are executed by a processor, the method according to any one of the first aspect is implemented.

In embodiments of the present disclosure, input information is input to a neural network to execute corresponding operation processing, where when convolution processing of a convolution layer of the neural network is executed, a convolution kernel of the convolution layer is updated based on a transformation matrix determined for each convolution layer, and corresponding convolution processing is completed by using the new convolution kernel. By means of the method, a corresponding transformation matrix is individually configured for each convolution layer, and a corresponding group effect is formed, where the group is not limited to a group of adjacent channels; moreover, the operation precision of a neural network can be further improved.

It should be understood that the above general description and the following detailed description are merely exemplary and explanatory, and are not intended to limit the present disclosure.

The other features and aspects of the present disclosure can be described more clearly according to the detailed descriptions of the exemplary embodiments in the accompanying drawings.

### BRIEF DESCRIPTION OF THE DRAWINGS

The drawings here incorporated in the description and constituting a part of the description describe the embodiments of the present disclosure and are intended to explain the technical solutions of the present disclosure together with the description.

FIG. 1 shows a flow chart of an information processing method according to embodiments of the present disclosure;

FIG. 2 shows a flow chart of updating a convolution kernel in an information processing method according to embodiments of the present disclosure;

FIG. 3 shows a schematic diagram of an existing conventional convolution operation;

FIG. 4 shows a schematic diagram of an existing convolution operation of group convolution;

FIG. 5 shows a schematic structural diagram of different transformation matrixes according to embodiments of the present disclosure;

FIG. 6 shows a flow chart of determining a transformation matrix in an information processing method according to embodiments of the present disclosure;

FIG. 7 shows a flow chart of a method for determining a second matrix constituting a transformation matrix of a convolution layer in an information processing method according to embodiments of the present disclosure;

FIG. 8 shows a flow chart of step S1012 in an information processing method according to embodiments of the present disclosure;

FIG. 9 shows a flow chart of step S103 in an information processing method according to embodiments of the present disclosure;

FIG. 10 shows a flow chart of training a neural network according to embodiments of the present disclosure;

FIG. 11 shows a block diagram of an information processing apparatus according to embodiments of the present disclosure;

FIG. 12 shows a block diagram of an electronic device according to embodiments of the present disclosure;

FIG. 13 shows another block diagram of an electronic device according to embodiments of the present disclosure.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” as used herein is merely the association relationship describing the associated objects, indicating that there may be three relationships, for example, A and/or B, which may indicate that A exists separately, both A and B exist, and B exists separately. In addition, the term “at least one” as used herein means any one of multiple elements or any combination of at least two of the multiple elements, for example, including at least one of A, B, or C, which indicates that any one or more elements selected from a set consisting of A, B, and C are included.

In addition, numerous details are given in the following detailed description for the purpose of better explaining the present disclosure. It should be understood by persons skilled in the art that the present disclosure may still be implemented even without some of those details. In some examples, methods, means, elements, and circuits that are well known to persons skilled in the art are not described in detail so that the principle of the present disclosure becomes apparent.

It should be understood that the foregoing various method embodiments mentioned in the present disclosure may be combined with each other to form a combined embodiment without departing from the principle logic. Details are not described herein again due to space limitation.

In addition, the present disclosure further provides an information processing apparatus, an electronic device, a computer-readable storage medium, and a program, which can all be used to implement any of the information processing methods provided by the present disclosure. For the corresponding technical solutions and descriptions, please refer to the corresponding content in the method section. Details are not described herein again.

An execution subject of the information processing apparatus in the embodiments of the present disclosure may be any electronic device or server, for example, an image processing device having an image processing function, a voice processing device having a voice processing function, and a video processing device having a video processing function, or the like, which may be mainly determined according to information to be processed. The electronic device may be a User Equipment (UE), a mobile device, a user terminal, a terminal, a cellular phone, a cordless phone, a Personal Digital Assistant (PDA), a handheld device, a computing device, a vehicle-mounted device, a wearable device, or the like. In some possible implementations, the information processing method may also be implemented by a processor by invoking computer-readable instructions stored in a memory.

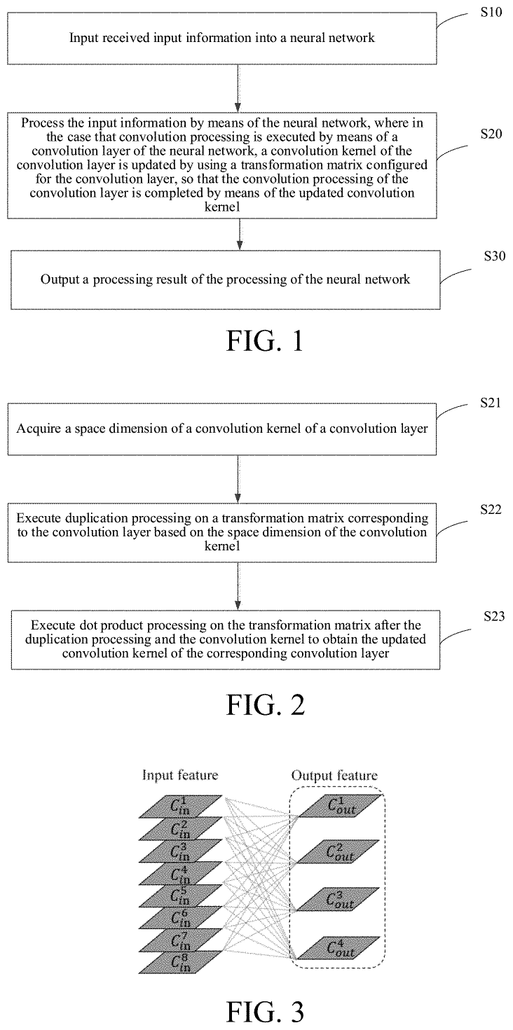

FIG. 1 shows a flow chart of an information processing method according to embodiments of the present disclosure. As shown in FIG. 1, the information processing method includes the following steps.

At S10, received input information is input into a neural network.

In some possible implementations, the input information may include at least one of a number, an image, a text, an audio, or a video, or other information may also be included in other implementations, which is not specifically defined in the present disclosure.

In some possible implementations, the information processing method provided in the present disclosure may be implemented by means of the neural network, and the neural network may be a trained network that can execute corresponding processing of the input information and satisfies the precision requirements. For example, the neural network in the embodiments of the present disclosure is a convolutional neural network, which may be a neural network having functions of target detection and target identification, so that detection and identification of a target object in a received image may be implemented, where the target object may be any type of object such as pedestrian, human face, vehicle, and animal, and may be specifically determined according to application scenes.

When processing of the input information is executed by means of the neural network, i.e., the input information is input to the neural network, a corresponding operation is executed by means of each network layer of the neural network. The neural network may include at least one convolution layer.

At S20, the input information is processed by means of the neural network, where in the case that convolution processing is executed by means of the convolution layer of the neural network, a convolution kernel of the convolution layer is updated by using a transformation matrix configured for the convolution layer, so that the convolution processing of the convolution layer is completed by means of the updated convolution kernel.

In some possible implementations, after the input information is input to the neural network, operation processing may be performed on the input information by means of the neural network, for example, operations such as vector operation or matrix operation, or addition, subtraction, multiplication and division operations may be executed for a feature of the input information. A specific operation type may be determined according to the structure of the neural network. In some embodiments, the neural network may include at least one convolution layer, a pooling layer, a full connection layer, a residual network, and a classifier, or other network layers may also be included in other embodiments, which is not specifically defined in the present disclosure.

When convolution processing in the neural network is executed, the embodiments of the present disclosure may update the convolution kernel of convolution operation of each convolution layer according to the transformation matrix configured for each convolution layer of the neural network. Different transformation matrixes may be configured for each convolution layer, the same transformation matrix may also be configured for each convolution layer, and the transformation matrix may also be a parameter matrix obtained by training and learning of the neural network, and may be specifically set according to requirements and application scenes. The dimension of the transformation matrix in the embodiments of the present disclosure is a product of the number of first channels of an input feature and the number of second channels of an output feature of the convolution layer, and may be, for example, Cᵢₙ×Cₒᵤₜ, where Cᵢₙ is the number of channels of the input feature of the convolution layer, and Cₒᵤₜ indicates the number of channels of the output feature of the convolution layer, and the transformation matrix may be constructed as a binaryzation matrix, where an element in the binaryzation matrix includes at least one of 0 or 1, i.e., the transformation matrix in the embodiments of the present disclosure may be a matrix consisting of at least one element of 0 or 1.

In some possible implementations, the transformation matrix corresponding to each convolution layer may be a matrix obtained by the training of the neural network, where when the neural network is trained, the transformation matrix may be introduced, and the transformation matrix that satisfies training requirements and is adapted to a training sample is determined in combination with a feature of the training sample. That is, the transformation matrix configured for each convolution layer in the embodiments of the present disclosure may enable a convolution mode of the convolution layer to adapt to a sample feature of the training sample, for example, different group convolutions of different convolution layers may be implemented. In order to improve the application precision of the neural network, in the embodiments of the present disclosure, the type of the input information is the same as that of the training sample used for training the neural network.

In some possible implementations, the transformation matrix of each convolution layer may be determined according to received configuration information, where the configuration information is information on the transformation matrix of the convolution layer. Furthermore, each transformation matrix is a set transformation matrix adapted to the input information, i.e., a transformation matrix that can obtain an accurate processing result. A method for receiving the configuration information may include receiving configuration information transmitted by other devices, or reading pre-stored configuration information and the like, which is not specifically defined in the present disclosure.

After obtaining the transformation matrix configured for each convolution layer, i.e., obtaining a new convolution kernel based on the configured transformation matrix, i.e., updating of the convolution kernel of the convolution layer is completed, where the convolution kernel is a convolution kernel determined by a convolution mode used in convolution processing in the prior art. When the neural network is trained, a specific parameter of the convolution kernel before updating may be obtained by means of training.

At S30, a processing result of the processing of the neural network is output.

After processing of the neural network, i.e., the processing result of the input information by the neural network may be obtained, the processing result may be output.

In some possible implementations, the input information may be image information, the neural network may be a network that detects the type of an object in the input information. In this case, the processing result may be the type of an object included in the image information. Alternatively, the neural network may detect a positional area where an object of a target type in the input information is located. In this case, the processing result is the positional area of the object of the target type included in the image information, where the processing result may also be a matrix form, which is not specifically defined in the present disclosure.

The steps of the information processing method in embodiments of the present disclosure are respectively described in detail below with reference to the accompanying drawings, where after the transformation matrix configured for each convolution layer is obtained, the convolution kernel of the corresponding convolution layer may be correspondingly updated according to the configured transformation matrix. FIG. 2 shows a flow chart of updating a convolution kernel in an information processing method according to embodiments of the present disclosure, where updating the convolution kernel of the convolution layer by the transformation matrix configured for the convolution layer includes the following steps.

At S21, a space dimension of the convolution kernel of the convolution layer is acquired.

In some possible implementations, after acquiring the transformation matrix configured for each convolution layer, an updating procedure of the convolution kernel may be executed, where the space dimension of the convolution kernel of each convolution layer may be acquired. For example, the dimension of the convolution kernel of each convolution layer in the neural network may be represented as k×k×Cᵢₙ×Cₒᵤₜ, where k×k is a space dimension of the convolution kernel, k is an integer greater than or equal to 1, may be, for example, a numerical value such as 3 or 5, and may be specifically determined according to the structure of the neural network; Cᵢₙ is the number of channels of the input feature of the convolution layer (the number of first channels), and Cₒᵤₜ indicates the number of channels of the output feature of the convolution layer (the number of second channels).

At S22, duplication processing is executed on the transformation matrix corresponding to the convolution layer based on the space dimension of the convolution kernel, where the number of times of duplication processing is determined by the space dimension of the convolution kernel.

In some possible implementations, the duplication processing may be executed on the transformation of the convolution layer based on the space dimension of the convolution kernel of the convolution layer, i.e., k×k transformation matrixes are duplicated, and a new matrix is formed by using the duplicated k×k transformation matrixes, where the formed new matrix has the same dimension as the convolution kernel.

At S23, dot product processing is executed on the transformation matrix after the duplication processing and the convolution kernel to obtain the updated convolution kernel of the corresponding convolution layer.

In some possible implementations, an updated convolution kernel may be obtained by using a dot product of the new matrix formed by the duplicated k×k transformation matrixes and the convolution kernel.

In some possible implementations, an expression for executing the convolution processing by using the updated convolution kernel in the present disclosure may include:

f_{i,j}′=Σₘ₌₀^{k-1}(U·ω_{m,n})f_{(i+m,j+n)}+b (1),

where f_{(i+m,j+n)} represents a feature unit in the (i+m)^{-th} row and the (j+n)^{-th} column in an input feature Fᵢₙ of the convolution layer, the size of Fᵢₙ may be represented as N×Cᵢₙ×H×W, N represents a sample amount of input features of the convolution layer, Cᵢₙ represents the number of channels of the input feature, H and W respectively represent the height and width of the input feature of a single channel, and f_{(i+m,j+n)}∈R^{N×C}^{ᵢₙ}; f_{i,j}′ represents a feature unit in the i-th row and the j-th column in an output feature Fₒᵤₜ of the convolution layer, Fₒᵤₜ∈R^{N×C}^{ₒᵤₜ}^{×H′×W′}, cₒᵤₜ represents the number of channels of the output feature, H′×W′ represents the height and width of the output feature of a single channel, ω_{m,n} represents a convolution unit in the m-th row and nth column in the convolution kernel of the convolution layer, the space dimension of the convolution kernel is k row and k column, U is the transformation matrix configured by the convolution layer (having the same dimension as the convolution unit), and b represents an optional bias term, which may be a numerical value greater than or equal to 0.

By means of the method above, an updating procedure of the convolution kernel of each convolution layer may be completed. Because the transformation matrix configured for each convolution layer may be in a different form, any convolution operation may be implemented.

In the prior art, when group convolution of convolution processing is implemented in the neural network, several important defects still exist in previous group convolution:

(1) a convolution parameter is determined depending on an artificial design mode, and an appropriate group num needs to be found by means of tedious experimental verification, so that said mode is not easy to popularize in practical application;

(2) existing applications all use the same type of group convolution strategy for all convolution layers of the whole network, such that on the one hand, it is difficult to manually select the group convolution strategy suitable for the whole network, and on the other hand, such an operation mode may not make the performance of the neural network reach an optimal state; and

(3) moreover, some group methods only divide the convolution features of adjacent channels into the same group, and such an easy-to-implement mode greatly ignores the relevance of feature information of different channels.

However, according to the embodiments of the present disclosure, individual meta convolution processing of each convolution layer is implemented by means of the adaptive transformation matrix configured for each convolution layer. In the case that the transformation matrix is a parameter obtained by the training of the neural network, independent learning of any group convolution scheme can be implemented for a deep neural network convolution layer without human intervention. Respective different group strategies are configured for different convolution layers of the neural network. A meta convolution method provided in the embodiments of the present disclosure may be applied to any convolution layer of a deep neural network, so that the convolution layers having different depths of the network all can independently select the optimal channel group scheme adapted to the current feature expression by means of learning. The convolution processing of the present disclosure has diversity. The meta convolution method is represented by a transformation matrix form, so that not only the existing adjacent group convolution technology may be expressed, but any channel group scheme can be expanded, the relevance of feature information of different channels is increased, and the cutting-edge development of a convolution redundancy elimination technology is promoted. In addition, the convolution processing provided in the embodiments of the present disclosure is further simple. The network parameter is decomposed by using Kronecker (Kronecker product) operation, and the meta convolution method provided in the present disclosure has the advantages such as small computation, small number of parameters, and easy implementation and application by means of a differentiable end-to-end training mode. The present disclosure further has versatility and is applicable to different network models and visual tasks. The meta convolution method may be easily and effectively applied to various convolutional neural networks to achieve excellent effects on various vision tasks, such as image classification (CIFAR10, ImageNet), target detection and identification (COCO, Kinetics), and image segmentation (Cityscapes, ADE2k).

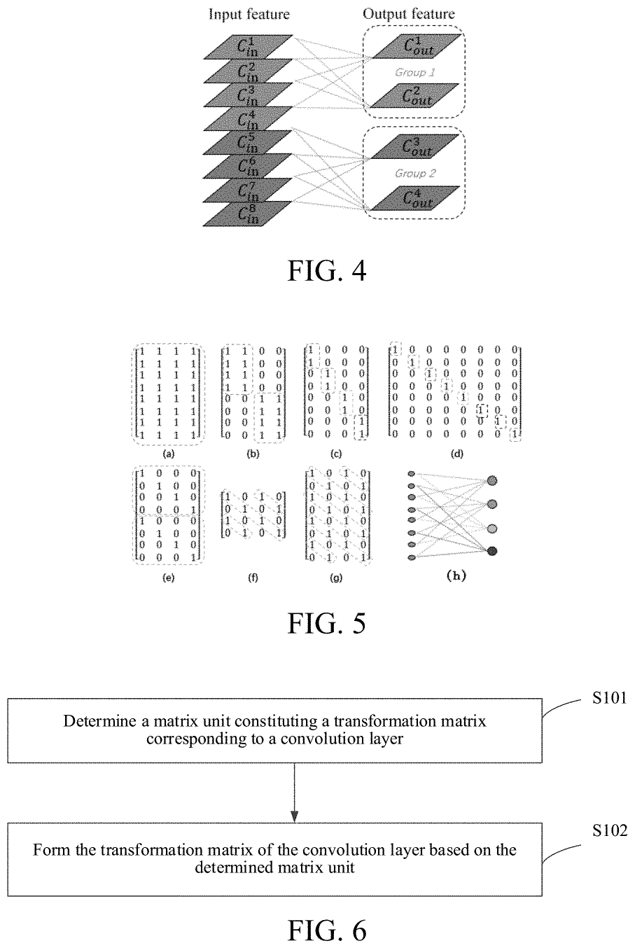

FIG. 3 shows a schematic diagram of an existing conventional convolution operation. FIG. 4 shows a schematic diagram of an existing convolution operation of group convolution. As shown in FIG. 3, for an ordinary convolution operation, each channel of output features of Cₒᵤₜ channels is obtained by performing a convolution operation of input features of all Cᵢₙ channels together. As shown in FIG. 4, conventional group convolution relates to performing grouping on dimension of channel, so as to arrive at the purpose of reducing the number of parameters. FIG. 4 intuitively indicates the group convolution operation having the group num of 2, i.e., the input features of every Cᵢₙ/2 channels is one group, which is convoluted with the weight of the dimension

$$\frac{{C}_{in}}{2} \times \frac{{C}_{out}}{2} \times k \times k ,$$

so that a group of output features of

$$\frac{{C}_{out}}{2}$$

channels is obtained. In this case, the total weight dimension is

$$2 \times \frac{{C}_{in}}{2} \times \frac{{C}_{out}}{2} \times k \times k ,$$

and the number of parameters is 2 times less than the ordinary convolution. Usually, the group num of the mode is manually set, and can be exactly divided by Cᵢₙ. When the group num equals the number of channels Cᵢₙ of the input feature, it is equivalent to respectively performing the convolution operation on the feature of each channel.

To understand a procedure of updating the convolution kernel by means of the transformation matrix to implement a new convolution mode (meta convolution) provided in the embodiments of the present disclosure more clearly, description is provided below by means of examples.

As stated in the foregoing embodiments, a transformation matrix U∈{0,1}^{C}^{ᵢₙ}^{×C}^{ₒᵤₜ} is a binaryzation matrix capable of learning, in which each element is either 0 or 1, and the dimension is the same as ω_{m,n}. In the embodiments of the present disclosure, performing dot product on a transformation matrix U and a convolution unit ω_{m,n} of the convolution layer is equivalent to performing sparse expression on the weight. Different Us represent different convolution operation methods, for example: FIG. 5 shows a schematic structural diagram of different transformation matrixes according to the embodiments of the present disclosure.

(1) When U is in the form of matrix a in FIG. 5, U is an all-ones matrix, where when a new convolution kernel is formed by using the transformation matrix, equivalent to changing the convolution kernel of the convolution operation, meta convolution represents an ordinary convolution operation, which corresponds to the convolution mode in FIG. 3. In this case Cᵢₙ=8, Cₒᵤₜ=4, and the group num is 1.

(2) When U is in the form of matrix b in FIG. 5, U is a block diagonal matrix, where when a new convolution kernel is formed by using the transformation matrix, the meta convolution represents the group convolution operation, which corresponds to the convolution mode in FIG. 4. In this case, Cᵢₙ=8, Cₒᵤₜ=4, and the group num is 2.

(3) When U is in the form of matrix c in FIG. 5, U is a block diagonal matrix, where when a new convolution kernel is formed by using the transformation matrix, the meta convolution represents the group convolution operation having the group num of 4, and similarly, Cᵢₙ=8, Cₒᵤₜ=4.

(4) When U is in the form of matrix d in FIG. 5, U is a unit matrix, where when a new convolution kernel is formed by using the transformation matrix, the meta convolution represents a group convolution operation that individual convolution is respectively performed on the feature of each channel. In this case, Cᵢₙ=Cₒᵤₜ=8, and the group num is 8.

(5) When U is a matrix of matrix g in FIG. 5, the meta convolution represents a convolution operation mode that has never happened before, where the output feature of each Cₒᵤₜ channel is not obtained by the input features of fixed adjacent Cᵢₙ channels. In this case any channel group scheme is possible. Matrix g may be a matrix obtained by means of matrixes e and f, and f in FIG. 5 represents a convolution form corresponding to matrix g.

It can be known from the foregoing exemplary descriptions that a method for updating the convolution kernel by means of the transformation matrix to implement meta convolution provided in the present disclosure achieves the sparse representation of the weight of the convolution layer, so that not only the existing convolution operation can be expressed, but also any channel group convolution scheme that has never happened before can be expanded. The method has richer expression capability than the previous convolution technology. Meanwhile, different from the previous convolution method in which the group num is artificially designed, the meta convolution can independently learn and adapt to the convolution scheme of the current data.

If the meta convolution method provided in the embodiments of the present disclosure is applied to any convolution layer of the deep neural network, the meta convolution method may be that the convolution layers having different depths of the network independently select the optimal channel group scheme adapted to the current feature expression by means of learning, where a corresponding binarization diagonal block matrix U is configured for each convolution layer, that is to say, in a deep neural network having L hidden layers, the meta convolution method brings a learning parameter of dimensional Cᵢₙ×Cₒᵤₜ×L. For example, in a 100-layer deep network, if the number of channels of each layer of a feature map is 1,000, millions of parameters are brought.

In some possible implementations, a configured transformation matrix may be directly obtained according to received configuration information, and the transformation matrix of each convolution layer may be directly determined by means of training of the neural network. In addition, in order to further reduce the optimization difficulty of the transformation matrix and reduce the amount of operation parameters, the embodiments of the present disclosure divide the transformation matrix into two matrixes multiplied by each other. That is to say, the transformation matrix in the embodiments of the present disclosure may include a first matrix and a second matrix, where the first matrix and the second matrix may be acquired according to the received configuration information, or the first matrix and the second matrix are obtained according to a training result. The first matrix is formed by connecting unit matrixes, and the second matrix is obtained by inner products of function transformations of a plurality of sub-matrixes. The transformation matrix may be obtained by means of a product of the first matrix and the second matrix.

FIG. 6 shows a flow chart of determining a transformation matrix in an information processing method according to embodiments of the present disclosure. Before executing the convolution processing by means of the convolution layer of the neural network, the transformation matrix corresponding to the convolution layer is determined. The step includes the following steps.

At S101, a matrix unit constituting the transformation matrix corresponding to the convolution layer is determined, where the matrix unit includes a second matrix, or includes a first matrix and the second matrix, where in response to the number of channels of an input feature and the number of channels of an output feature of the convolution layer being different, the transformation matrix corresponding to the convolution layer includes the first matrix and the second matrix; and in response to the number of channels of the input feature and the number of channels of the output feature of the convolution layer being identical, a binaryzation matrix corresponding to the convolution layer includes the second matrix, where the first matrix is formed by connecting unit matrixes, and the second matrix is obtained by inner products of function transformations of the plurality of sub-matrixes.

At S102, the transformation matrix of the convolution layer is formed based on the determined matrix unit.

In some possible implementations, for the case that the numbers of channels of the input feature and the output feature of the convolution layer are the same or different, the matrix unit constituting the transformation matrix may be determined in different modes. For example, in the case that the number of channels of the input feature and the number of channels of the output feature of the convolution layer are the same, the matrix unit constituting the transformation matrix of the convolution layer is the second matrix, and in the case that the number of channels of the input feature and the number of channels of the output feature of the convolution layer are different, the matrix unit constituting the transformation matrix of the convolution layer may be the first matrix and the second matrix.

In some possible implementations, the first matrix and the second matrix corresponding to the transformation matrix may be obtained according to the received configuration information, and related parameters of the first matrix and the second matrix may also be trained and learned by means of the neural network.

In the embodiments of the present disclosure, the first matrix constituting the transformation matrix is formed by connecting the unit matrixes, and in the case that the number of first channels of the input feature and the number of second channels of the output feature of the convolution layer are determined, the dimensions of the first matrix and the second matrix may be determined. In the case that the number of the first channels is greater than the number of the second channels, the dimension of the first matrix is Cᵢₙ×Cₒᵤₜ, and the dimension of the second matrix is Cₒᵤₜ×Cₒᵤₜ. In the case that the number of the first channels is less than the number of the second channels, the dimension of the first matrix is Cᵢₙ×Cₒᵤₜ, and the dimension of second matrix Ũ is Cᵢₙ×Cᵢₙ. In the embodiments of the present disclosure, the dimension of the first matrix may be determined based on the number of the first channels of the input feature and the number of the second channels of the output feature of the convolution layer, and a plurality of unit matrixes forming the first matrix by means of connection may be determined based on the dimension, where the form of the first matrix may be easily obtained because the unit matrix is a square matrix.

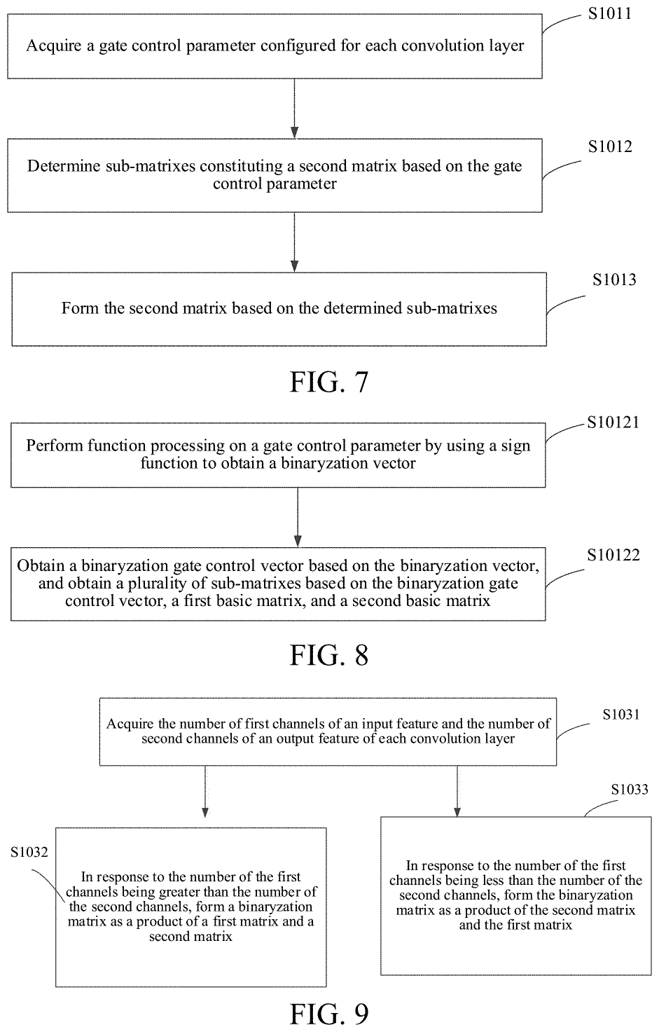

For the second matrix forming the transformation matrix, the embodiments of the present disclosure may determine the second matrix according to an obtained gate control parameter. FIG. 7 shows a flow chart of a method for determining a second matrix of a transformation matrix of a convolution layer in an information processing method according to the embodiments of the present disclosure, where determining the second matrix constituting the transformation matrix of the convolution layer includes the following steps.

At S1011, a gate control parameter configured for each convolution layer is acquired.

At S1012, the sub-matrixes constituting the second matrix are determined based on the gate control parameter.

At S1013, the second matrix is formed based on the determined sub-matrixes.

In some possible implementations, the gate control parameter may include a plurality of numerical values, which may be floating point type decimals near 0, such as a float 64-bit or 32-bit decimal, which is not specifically defined in the present disclosure. The received configuration information may include the continuous numerical values, or the neural network may also learn and determine the continuous numerical values by training.

In some possible implementations, the second matrix may be obtained by means of the inner product operation of the plurality of sub-matrixes, the gate control parameter obtained by means of step S1011 may form the plurality of sub-matrixes, and then, the second matrix is obtained according to an inner product operation result of the plurality of sub-matrixes.

FIG. 8 shows a flow chart of step S1012 in an information processing method according to embodiments of the present disclosure, where determining the sub-matrixes constituting the second matrix based on the gate control parameter may include the following steps.

At S10121, function processing is performed on the gate control parameter by using a sign function to obtain a binaryzation vector.

In some possible implementations, each parameter numerical value of the gate control parameter may be input to the sign function, a corresponding result may be obtained by means of processing of the sign function, and the binaryzation vector may be constituted based on an operation result of the sign function corresponding to each gate control parameter.

The expression of the binaryzation vector may be represented as:

g=sign(\tilde{g}) (2);

where \tilde{g} is a gate control parameter, and g is a binaryzation vector. For sign function f(a)=sign(a), if a is greater than or equal to zero, sign(a) equals 1, and if a is less than zero, sign(a) equals 0. Therefore, after the processing of the sign function, an element in the obtained binaryzation vector may include at least one of 0 or 1, and the number of elements is the same as the number of continuous numerical values of the gate control parameter.

At S10122, a binaryzation gate control vector is obtained based on the binaryzation vector, and the plurality of sub-matrixes is obtained based on the binaryzation gate control vector, a first basic matrix, and a second basic matrix.

In some possible implementations, the element of the binaryzation vector may be directly determined as the binaryzation gate control vector, i.e., no processing is performed on the binaryzation vector, where the expression of the binaryzation gate control vector may be: \vec{g}=g, where \vec{g} represents the binaryzation gate control vector. Furthermore, the plurality of sub-matrixes constituting the second matrix may be formed according to the binaryzation gate control vector, the first basic matrix, and the second basic matrix. In the embodiments of the present disclosure, the first matrix may be the all-ones matrix, and the second basic matrix is the unit matrix. A mode of a convolution group formed by the second matrix determined by means such a mode may be any group mode, such as a convolution form of g in FIG. 5.

In some other possible implementations, in order to implement the form of block group convolution of the convolution layer, the binaryzation gate control vector may be obtained by using a product of a permutation matrix and the binaryzation vector, where the permutation matrix may be an ascending sort matrix, in which the binarization vectors are ranked so that 0 in the obtained binarization gated vector is before 1, where the expression of the binaryzation gate control vector may be: \vec{g}=Pg, and P is a permutation matrix. Furthermore, the plurality of sub-matrixes constituting the second matrix may be formed according to the binaryzation gate control vector, the first basic matrix, and the second basic matrix.

In some possible implementations, obtaining the plurality of sub-matrixes based on the binaryzation gate control vector, the first basic matrix, and the second basic matrix may include: in response to an element in the binaryzation gate control vector being a first numerical value, obtaining a sub-matrix of an all-ones matrix; and in response to the element in the binaryzation gate control vector being a second numerical value, obtaining a sub-matrix of the unit matrix, where the first numerical value is 1, and the second numerical value is 0. That is to say, the sub-matrixes obtained in the embodiments of the present disclosure may be the all-ones matrix or the unit matrix, where a corresponding sub-matrix is the all-ones matrix when the element in the binaryzation gate control vector is 1, and a corresponding sub-matrix is the unit matrix when the element in the binaryzation gate control vector is 0.

In some possible implementations, the corresponding sub-matrix may be obtained for each element in the binaryzation gate control vector, where a mode for obtaining the sub-matrix may include:

obtaining a first vector by multiplying the element in the binaryzation gate control vector by the first basic matrix;

obtaining a second vector by multiplying the element in the binaryzation gate control vector by the second basic matrix; and

obtaining the corresponding sub-matrix by using a difference between a sum result of the first vector and the second basic matrix and the second vector.

The expression of obtaining the plurality of sub-matrixes may be:

Ũᵢ=gᵢ1+(1−gᵢ)I,∀gᵢ∈\vec{g} (3).

The i-th element gᵢ in binaryzation gate control vector \vec{g} may be multiplied by a first basic matrix 1 to obtain the first vector; the i-th element gᵢ is multiplied by a second basic matrix I to obtain the second vector, and a sum operation is performed on the first vector and the second basic vector to obtain a sum result; and the i-th sub-matrix Ũᵢ is obtained by using a difference between the sum result and the second vector, where i is an integer greater than 0 and less than or equal to K, and K is the number of elements of the binaryzation gate control vector.

Based on the foregoing configuration of the embodiments of the present disclosure, the sub-matrixes may be determined based on the obtained gate control parameter, so as to further determine the second matrix. In the case of training and learning by means of the neural network, the learning of a second matrix Ũ of C×C dimension may be converted to the learning of a series of sub-matrixes Ũᵢ, and the number of parameters is also reduced to

$${\sum }_{i} {C}_{i}^{2}$$

from CXC, where i represents the number of sub-matrixes. For example, the second matrix may be decomposed to three sub-matrixes of 2×2 to perform the Kronecker inner product operation, i.e.:

$$\tilde{U} = I ⊗ I ⊗ 1 = [ \begin{matrix}1 & 0 \\ 0 & 1\end{matrix} ] ⊗ [ \begin{matrix}1 & 0 \\ 0 & 1\end{matrix} ] ⊗ [ \begin{matrix}1 & 1 \\ 1 & 1\end{matrix} ] = [ \begin{matrix}1 & 0 & 0 & 0 \\ 0 & 1 & 0 & 0 \\ 0 & 0 & 1 & 0 \\ 0 & 0 & 0 & 1\end{matrix} ] ⊗ [ \begin{matrix}1 & 1 \\ 1 & 1\end{matrix} ] = [ \begin{matrix}1 & 1 & 0 & 0 & 0 & 0 & 0 & 0 \\ 1 & 1 & 0 & 0 & 0 & 0 & 0 & 0 \\ 0 & 0 & 1 & 1 & 0 & 0 & 0 & 0 \\ 0 & 0 & 1 & 1 & 0 & 0 & 0 & 0 \\ 0 & 0 & 0 & 0 & 1 & 1 & 0 & 0 \\ 0 & 0 & 0 & 0 & 1 & 1 & 0 & 0 \\ 0 & 0 & 0 & 0 & 0 & 0 & 1 & 1 \\ 0 & 0 & 0 & 0 & 0 & 0 & 1 & 1\end{matrix} ] . \qquad ( 4 )$$

In this case, the number of parameters is reduced to 3×2\hat{ }2=12 from 8\hat{ }2=64. Obviously, the amount of operation of convolution processing may be reduced by means of the mode in the embodiments of the present disclosure.

As stated above, after obtaining the sub-matrixes, the second matrix may be obtained based on the inner product operation of the sub-matrixes, where the expression of the second matrix is:

Ũ=Ũ₁⊗Ũ₂⊗ . . . ⊗Ũ_{K};

where Ũ represents the second matrix, ⊗ represents the inner product operation, and Ũᵢ represents the i-th sub-matrix.

The inner product operation represents an operation between any two matrixes, and may be defined as:

$$[ \begin{matrix}{a}_{11} & {a}_{12} \\ {a}_{21} & {a}_{22}\end{matrix} ] ⊗ [ \begin{matrix}{b}_{11} & {b}_{12} \\ {b}_{21} & {b}_{22}\end{matrix} ] = [ \begin{matrix}{a}_{11} {b}_{11} & {a}_{11} {b}_{12} & {a}_{12} {b}_{11} & {a}_{12} {b}_{12} \\ {a}_{11} {b}_{21} & {a}_{11} {b}_{22} & {a}_{12} {b}_{21} & {a}_{12} {b}_{22} \\ {a}_{21} {b}_{11} & {a}_{21} {b}_{12} & {a}_{22} {b}_{11} & {a}_{22} {b}_{12} \\ {a}_{21} {b}_{21} & {a}_{21} {b}_{22} & {a}_{22} {b}_{21} & {a}_{22} {b}_{22}\end{matrix} ] . \qquad ( 5 )$$

By means of the foregoing configuration, the embodiments of the present disclosure may determine that the sub-matrixes of the second matrix are formed. If the number of the first channels of the input feature and the number of the second channels of the convolution layer are the same, the second matrix may be the transformation matrix; if the number of the first channels and the number of the second channels are different, the transformation matrix may be determined according to the first matrix and the second matrix. In this case, a long matrix (the transformation matrix) of Cᵢₙ×Cₒᵤₜ dimension is represented by using the first matrix formed by connecting the unit matrixes and a square matrix Ũ (the second matrix) of C×C dimension, where C is the smaller numerical value in the number of channels of the input feature Cᵢₙ and the number of channels of the output feature Cₒᵤₜ of the convolution layer, i.e., C=min(Cᵢₙ,Cₒᵤₜ).

FIG. 9 shows a flow chart of step S103 in an information processing method according to embodiments of the present disclosure. Forming the transformation matrix of the convolution layer based on the determined matrix unit includes the following steps.

At S1031, the number of first channels of the input feature and the number of second channels of the output feature of each convolution layer are acquired.

At S1032, in response to the number of the first channels being greater than the number of the second channels, the transformation matrix is formed as a product of the first matrix and the second matrix.

At S1033, in response to the number of the first channels being less than the number of the second channels, the transformation matrix is formed as a product of the second matrix and the first matrix.

As stated above, the embodiments of the present disclosure may acquire the first matrix and the second matrix constituting the transformation matrix, where the first matrix and the second matrix may be obtained based on the received configuration information as stated in the embodiments above, and may also be obtained by means of the training of the neural network. When the transformation matrix corresponding to each convolution layer is formed, a mode of forming the first matrix and the second matrix may be first determined according to the number of channels of the input feature and the number of channels of the output feature in the convolution layer.

If the number of channels (the number of first channels) of the input feature is greater than the number of channels (the number of second channels) of the output feature, the transformation matrix is a result of multiplying the first matrix by the second matrix. If the number of channels of the input feature is less than the number of channels of the output feature, the transformation matrix is a result of multiplying the second matrix by the first matrix. If the numbers of channels of the input feature and the output feature are the same, the transformation matrix may be determined by multiplying the first matrix by the second matrix or multiplying the second matrix by the first matrix.

In the case that Cᵢₙ and Cₒᵤₜ are equal, the second matrix in the embodiments of the present disclosure may serve as the transformation matrix. Descriptions are not made herein specifically. The determining of the first matrix and the second matrix that constitute the transformation matrix is described for the case that Cᵢₙ and Cₒᵤₜ are unequal below.

When Cᵢₙ is greater than Cₒᵤₜ, the transformation matrix equals a product of a first matrix Ĩ_{d} and a second matrix Ũ. In this case, the dimension of the first matrix Ĩ_{d} is Cᵢₙ×Cₒᵤₜ, the expression of the first matrix is Ĩ_{d}∈{0,1}^{C}^{ᵢₙ}^{×C}^{ₒᵤₜ}, the dimension of the second matrix Ũ is Cₒᵤₜ×Cₒᵤₜ, and the expression of the second matrix is Ũ∈{0,1}^{C}^{ₒᵤₜ}^{×C}^{ₒᵤₜ}. The first matrix and the second matrix each are a matrix consisting of at least one element of 0 or 1, and correspondingly, the expression of the transformation matrix U is: U=Ĩ_{d}×Ũ, where the first matrix Ĩ_{d} is formed by connecting unit matrixes I, the dimension of I is Cₒᵤₜ×Cₒᵤₜ, and the expression of the unit matrix I is I∈{0,1}^{C}^{ₒᵤₜ}^{×C}^{ₒᵤₜ}. For example, when the transformation matrix is a fringe matrix shown in g of FIG. 4, Cᵢₙ=8 and Cₒᵤₜ=4, the first matrix Ĩ_{d} having the dimension of 8×4 and the second matrix Ũ having the dimension of 4×4 may be constituted.

When Cᵢₙ is less than Cₒᵤₜ, the transformation matrix equals a product of a second matrix Ũ and a first matrix Ĩᵤ, where the dimension of the first matrix Ĩᵤ is Cᵢₙ×Cₒᵤₜ, the expression of the first matrix is Ĩᵤ∈{0,1}^{C}^{ᵢₙ}^{×C}^{ₒᵤₜ}, the dimension of the second matrix Ũ is Cᵢₙ×Cᵢₙ, and the expression of the second matrix is Ũ∈{0,1}^{C}^{ᵢₙ}^{×C}^{ᵢₙ}. The first matrix and the second matrix each are a matrix consisting of at least one element of 0 or 1, and correspondingly, the expression of the transformation matrix U is: U=Ũ×Ĩᵤ, where the first matrix Ĩᵤ formed by connecting unit matrixes I, the dimension of I is Cᵢₙ×Cᵢₙ, and the expression of the unit matrix I is I∈{0,1}^{C}^{ᵢₙ}^{×C}^{ᵢₙ}.

By means of the mode above, the first matrix and the second matrix constituting the transformation matrix may be determined, where, as stated above, the first matrix is formed by connecting the unit matrixes, and after the number of channels of the input feature and the number of channels of the output feature are determined, the first matrix is also determined, accordingly. In the case that the dimension of the second matrix is known, an element value in the second matrix may be further determined. The second matrix in the embodiments of the present disclosure may be obtained by inner products of function transformations of the plurality of sub-matrixes.

In some possible implementations, the gate control parameter \tilde{g} of each convolution layer may be learnt when performing training by means of the neural network. Alternatively, the received configuration information may include the gate control parameter configured for each convolution layer, so that the transformation matrix corresponding to each convolution layer may be determined by means of the mode above, and the number of parameters of the second matrix Ũ is also reduced to merely i parameters from

$${\sum }_{i} {C}_{i}^{2} .$$

Alternatively, the received configuration information may also merely include the gate control parameter \tilde{g} corresponding to each convolution layer, and the sub-matrixes and the second matrix may be further determined by means of the mode above.

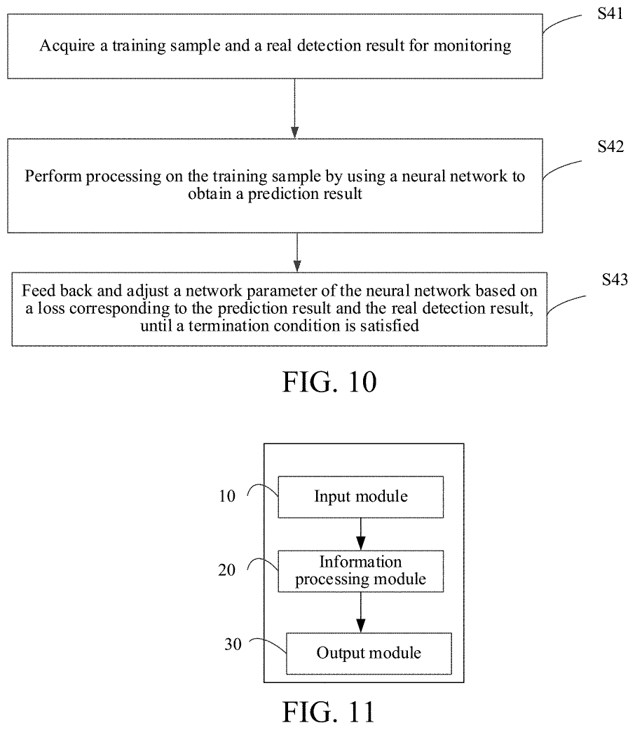

The specific steps of training the neural network are described for examples of implementing the information processing method in the embodiments of the present disclosure by means of the neural network below. FIG. 10 shows a flow chart of training a neural network according to the embodiments of the present disclosure. The step of training the neural network includes the following steps.

At S41, a training sample and a real detection result for monitoring are acquired.

In some possible implementations, the training sample may be sample data of the foregoing type of the input information, such as at least one of text information, image information, video information, or voice information. The real detection result for monitoring is a real result of a training sample to be predicted, such as an object type in an image and a position of a corresponding object, which is not specifically defined in the present disclosure.

At S42, processing is performed on the training sample by using the neural network to obtain a prediction result.

In some possible implementations, sample data in the training sample may be input to the neural network, and a corresponding prediction result is obtained by means of the operation of each network layer in the neural network. The convolution processing of the neural network may be executed based on the information processing mode, i.e., updating the convolution kernel of the network layer by using a pre-configured transformation matrix, and convolution operation is executed by using a new convolution kernel. A processing result obtained by the neural network is a prediction result.

At S43, a network parameter of the neural network is fed back and adjusted based on a loss corresponding to the prediction result and the real detection result, until a termination condition is satisfied, where the network parameter includes the convolution kernel of each network layer and the transformation matrix (including the continuous values in the gate control parameter).

In some possible implementations, a loss value corresponding to the prediction result and the real detection result may be obtained by using a preset loss function. If the loss value is greater than a loss threshold, the network parameter of the neural network is fed back and adjusted, and the prediction result corresponding to the sample data is re-predicted by using the neural network having the adjusted parameter, until the loss corresponding to the prediction result is less than the loss threshold, i.e., it indicates that the neural network satisfies the precision requirements, and training may be terminated in this case. The preset loss function may be a subtraction operation between the prediction result and the real detection result, i.e., the loss value is a difference between the prediction result and the real detection result. In other embodiments, the preset loss function may also be other forms, which is not specifically defined in the present disclosure.

The training of the neural network may be completed by means of the mode above, and the transformation matrix configured for each convolution layer of the neural network may be obtained, so that the meta convolution operation of each convolution layer may be completed.

In summary, in embodiments of the present disclosure, the input information may be input to the neural network to execute corresponding operation processing, where when convolution processing of the convolution layer of the neural network is executed, the convolution kernel of the convolution layer may be updated based on the transformation matrix determined for each convolution layer, and corresponding convolution processing is completed by using a new convolution kernel. By means of the mode, a corresponding transformation matrix may be individually configured for each convolution layer, a corresponding group effect is formed, where the group is not limited to a group of adjacent channels, and the operation precision of the neural network may be further improved.

In addition, compared with the defects of the previous technologies in artificially setting the group num for a specific task, the technical solutions of the embodiments of the present disclosure may implement independent learning of any group convolution scheme for the deep neural network convolution layer without human intervention. Furthermore, the embodiments of the present disclosure may not only express the existing adjacent group convolution technologies, but also expand any channel group scheme, the relevance of feature information of different channels is increased, and the cutting-edge development of the convolution redundancy elimination technology is promoted. The meta convolution method provided in the present disclosure is applied to any convolution layer of the deep neural network, so that the convolution layers having different depths of the network can all independently select the channel group scheme adapted to the current feature expression by means of learning. Compared with the traditional strategy that the whole network uses single type group convolution, the optimal performance model can be obtained. In addition, in the present disclosure, the network parameter is decomposed by using Kronecker operation, and the meta convolution method provided in the embodiments of the present disclosure has the advantages such as small computation, small number of parameters, and easy implementation and application by means of the differentiable end-to-end training mode.

It can be understood by a person skilled in the art that, in the foregoing methods of the specific implementations, the order in which the steps are written does not imply a strict execution order which constitutes any limitation to the implementation process, and the specific order of executing the steps should be determined by functions and possible internal logics thereof.

FIG. 11 shows a block diagram of an image processing apparatus according to embodiments of the present disclosure. As shown in FIG. 11, the image processing apparatus includes:

an input module 10 configured to input received input information to a neural network;

an information processing module 20 configured to process the input information by means of the neural network, where in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and

an output module 30 configured to output a processing result of the processing of the neural network.

In some possible implementations, the information processing module is further configured to acquire a space dimension of the convolution kernel of the convolution layer;

execute duplication processing on the transformation matrix corresponding to the convolution layer based on the space dimension of the convolution kernel, where the number of times of duplication processing is determined by the space dimension of the convolution kernel; and

execute dot product processing on the transformation matrix after the duplication processing and the convolution kernel to obtain the updated convolution kernel of the corresponding convolution layer.

In some possible implementations, the information processing module is further configured to determine a matrix unit constituting the transformation matrix corresponding to the convolution layer, and form the transformation matrix of the convolution layer based on the determined matrix unit, where the matrix unit includes a first matrix and a second matrix, or only includes the second matrix, where in response to the number of channels of an input feature and the number of channels of an output feature of the convolution layer being different, the transformation matrix corresponding to the convolution layer includes the first matrix and the second matrix; and in response to the number of channels of the input feature and the number of channels of the output feature of the convolution layer being identical, the transformation matrix corresponding to the convolution layer includes the second matrix, where the first matrix is formed by connecting unit matrixes, and the second matrix is obtained by inner products of function transformations of a plurality of sub-matrixes.

In some possible implementations, the information processing module is further configured to acquire a gate control parameter configured for each convolution layer;

determine the sub-matrixes constituting the second matrix based on the gate control parameter; and

form the second matrix based on the determined sub-matrixes.

In some possible implementations, the information processing module is further configured to acquire the gate control parameter configured for each convolution layer according to received configuration information; or

determine the gate control parameter configured for the convolution layer based on a training result of the neural network.

In some possible implementations, the information processing module is further configured to acquire the number of first channels of the input feature and the number of second channels of the output feature of each convolution layer;

in response to the number of the first channels being greater than the number of the second channels, form the transformation matrix as a product of the first matrix and the second matrix; and

in response to the number of the first channels being less than the number of the second channels, form the transformation matrix as a product of the second matrix and the first matrix.

In some possible implementations, the information processing module is further configured to perform function processing on the gate control parameter by using a sign function to obtain a binaryzation vector; and

obtain a binaryzation gate control vector based on the binaryzation vector, and obtain the plurality of sub-matrixes based on the binaryzation gate control vector, a first basic matrix, and a second basic matrix.

In some possible implementations, the information processing module is further configured to determine the binaryzation vector as the binaryzation gate control vector; or

determine a product of a permutation matrix and the binaryzation vector as the binaryzation gate control vector.

In some possible implementations, the information processing module is further configured to obtain a sub-matrix of an all-ones matrix in the case that an element in the binaryzation gate control vector is a first numerical value; and

obtain a sub-matrix of the unit matrix in the case that an element in the binaryzation gate control vector is a second numerical value.

In some possible implementations, the first basic matrix is the all-ones matrix, and the second basic matrix is the unit matrix.

In some possible implementations, the information processing module is further configured to perform an inner product operation on the plurality of sub-matrixes to obtain the second matrix.

In some possible implementations, the input information includes at least one of text information, image information, video information, or voice information.

In some possible implementations, the dimension of the transformation matrix is a product of the number of the first channels and the number of the second channels, the number of the first channels is the number of channels of the input feature of the convolution layer, the number of the second channels is the number of channels of the output feature of the convolution layer, and an element of the transformation matrix includes at least one of 0 or 1.

In some possible implementations, the information processing module is further configured to train the neural network, where a step of training the neural network includes:

acquiring a training sample and a real detection result for monitoring;

performing processing on the training sample by using the neural network to obtain a prediction result; and

feeding back and adjusting a network parameter of the neural network based on a loss corresponding to the prediction result and the real detection result, until a termination condition is satisfied, where the network parameter includes the convolution kernel of each network layer and the transformation matrix.

In some embodiments, the functions provided by or the modules included in the apparatus provided in the embodiments of the present disclosure may be used for implementing the method described in the foregoing method embodiments. For specific implementations, reference may be made to the description in the method embodiments above. For the purpose of brevity, details are not described herein again.

Further provided in embodiments of the present disclosure is a computer-readable storage medium, having computer program instructions stored thereon, where when the computer program instructions are executed by a processor, the foregoing method is implemented. The computer-readable storage medium may be a non-volatile computer-readable storage medium.

Further provided in embodiments of the present disclosure is an electronic device, including: a processor; and a memory configured to store processor-executable instructions, where the processor is configured to execute the foregoing method.

The electronic device may be provided as a terminal, a server, or other forms of devices.

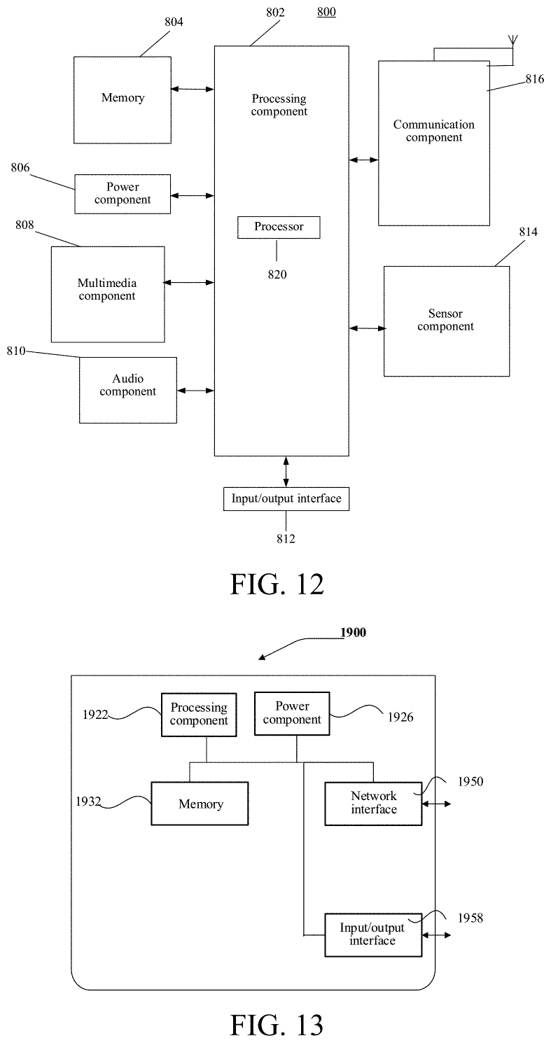

FIG. 12 shows a block diagram of an electronic device according to embodiments of the present disclosure. For example, an electronic device 800 may be a terminal such as a mobile phone, a computer, a digital broadcast terminal, a message transceiver device, a game console, a tablet device, a medical device, exercise equipment, and a personal digital assistant.

Referring to FIG. 12, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 generally controls the overall operation of the electronic device 800, such as operations associated with display, phone calls, data communications, camera operations, and recording operations. The processing component 802 may include one or more processors 820 to execute instructions to implement all or some of the steps of the foregoing method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and etc. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power component 806 provides power for various components of the electronic device 800. The power component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. The front-facing camera and the rear-facing camera each may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The buttons may include, but are not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In exemplary embodiments, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In exemplary embodiments, further provided is a non-volatile computer-readable storage medium, for example, a memory 804 including computer program instructions, which can be executed by the processor 820 of the electronic device 800 to implement the methods above.

FIG. 13 shows another block diagram of an electronic device according to embodiments of the present disclosure. For example, an electronic device 1900 may be provided as a server. Referring to FIG. 13, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. Further, the processing component 1922 may be configured to execute instructions so as to execute the foregoing method.

The electronic device 1900 may further include a power component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™ or the like.

In exemplary embodiments, further provided is a non-volatile computer-readable storage medium, for example, a memory 1932 including computer program instructions, which can be executed by the processing component 1922 of the electronic device 1900 to implement the foregoing method.

The present disclosure may be a system, a method, and/or a computer program product. The computer program product may include a computer-readable storage medium having computer-readable program instructions thereon for causing a processor to carry out aspects of the present disclosure.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include: a portable computer diskette, a hard disk, a Random Access Memory (RAM), an ROM, an EPROM (or a flash memory), a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination thereof. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a Local Area Network (LAN), a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In a scenario involving a remote computer, the remote computer may be connected to the user's computer through any type of network, including a LAN or a Wide Area Network (WAN), or the connection may be made to an external computer (for example, through the Internet using an Internet service provider). In some embodiments, electronic circuitry including, for example, programmable logic circuitry, Field-Programmable Gate Arrays (FGPAs), or Programmable Logic Arrays (PLAs) may execute the computer-readable program instructions by utilizing state information of the computer-readable program instructions to personalize the electronic circuitry, in order to implement the aspects of the present disclosure.

The aspects of the present disclosure are described herein with reference to flowcharts and/or block diagrams of methods, apparatuses (systems), and computer program products according to the embodiments of the present disclosure. It should be understood that each block of the flowcharts and/or block diagrams, and combinations of the blocks in the flowcharts and/or block diagrams can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can cause a computer, a programmable data processing apparatus, and/or other devices to function in a particular manner, such that the computer-readable medium having instructions stored therein includes an article of manufacture instructing instructions which implement the aspects of the functions/acts specified in one or more blocks of the flowcharts and/or block diagrams.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus or other device implement the functions/acts specified in one or more blocks of the flowcharts and/or block diagrams.

The flowcharts and block diagrams in the accompanying drawings illustrate the architecture, functionality and operations of possible implementations of systems, methods, and computer program products according to multiple embodiments of the present disclosure. In this regard, each block in the flowchart of block diagrams may represent a module, segment, or portion of instruction, which includes one or more executable instructions for implementing the specified logical function(s). In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, can be implemented by special purpose hardware-based systems that perform the specified functions or acts or carried out by combinations of special purpose hardware and computer instructions.

The descriptions of the embodiments of the present disclosure have been presented for purposes of illustration, but are not intended to be exhaustive or limited to the embodiments disclosed. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. An information processing method, applied in a neural network and comprising:
inputting received input information into the neural network;
processing the input information by means of the neural network, wherein in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and
outputting a processing result of the processing of the neural network.

2. The method according to claim 1, wherein updating the convolution kernel of the convolution layer by using the transformation matrix configured for the convolution layer comprises:
acquiring a space dimension of the convolution kernel of the convolution layer;
executing duplication processing on the transformation matrix corresponding to the convolution layer based on the space dimension of the convolution kernel, wherein the number of times of duplication processing is determined by the space dimension of the convolution kernel; and
executing dot product processing on the transformation matrix after the duplication processing and the convolution kernel to obtain the updated convolution kernel of the corresponding convolution layer.

3. The method according to claim 1, before executing convolution processing by means of the convolution layer of the neural network, further comprising:
determining a matrix unit constituting the transformation matrix corresponding to the convolution layer, wherein the matrix unit comprises a first matrix and a second matrix, or only comprises the second matrix, wherein in response to the number of channels of an input feature and the number of channels of an output feature of the convolution layer being different, the transformation matrix corresponding to the convolution layer comprises the first matrix and the second matrix; and in response to the number of channels of the input feature and the number of channels of the output feature of the convolution layer being identical, the transformation matrix corresponding to the convolution layer comprises the second matrix, wherein the first matrix is formed by connecting unit matrixes, and the second matrix is obtained by inner products of function transformations of a plurality of sub-matrixes; and
forming the transformation matrix of the convolution layer based on the determined matrix unit.

4. The method according to claim 3, wherein determining the second matrix constituting the transformation matrix of the convolution layer comprises:
acquiring a gate control parameter configured for each convolution layer;
determining the sub-matrixes constituting the second matrix based on the gate control parameter; and
forming the second matrix based on the determined sub-matrixes.

5. The method according to claim 4, wherein acquiring the gate control parameter configured for each convolution layer comprises:
acquiring the gate control parameter configured for each convolution layer according to received configuration information; or
determining the gate control parameter configured for the convolution layer based on a training result of the neural network.

6. The method according to claim 3, wherein forming the transformation matrix of the convolution layer based on the determined matrix unit comprises:
acquiring the number of first channels of the input feature and the number of second channels of the output feature of each convolution layer;
in response to the number of the first channels being greater than the number of the second channels, forming the transformation matrix as a product of the first matrix and the second matrix; and
in response to the number of the first channels being less than the number of the second channels, forming the transformation matrix as a product of the second matrix and the first matrix.

7. The method according to claim 4, wherein determining the sub-matrixes constituting the second matrix based on the gate control parameter comprises:
performing function processing on the gate control parameter by using a sign function to obtain a binaryzation vector; and
obtaining a binaryzation gate control vector based on the binaryzation vector, and obtaining the plurality of sub-matrixes based on the binaryzation gate control vector, a first basic matrix, and a second basic matrix, and
wherein obtaining the binaryzation gate control vector based on the binaryzation vector comprises:
determining the binaryzation vector as the binaryzation gate control vector; or
determining a product of a permutation matrix and the binaryzation vector as the binaryzation gate control vector.

8. The method according to claim 7, wherein obtaining the plurality of sub-matrixes based on the binaryzation gate control vector, the first basic matrix, and the second basic matrix comprises:
in response to an element in the binaryzation gate control vector being a first numerical value, obtaining a sub-matrix of an all-ones matrix; and
in response to the element in the binaryzation gate control vector being a second numerical value, obtaining a sub-matrix of the unit matrix,
wherein the first basic matrix is the all-ones matrix, and the second basic matrix is the unit matrix.

9. The method according to claim 1, wherein the dimension of the transformation matrix is a product of the number of the first channels and the number of the second channels, the number of the first channels is the number of channels of the input feature of the convolution layer, the number of the second channels is the number of channels of the output feature of the convolution layer, and an element of the transformation matrix comprises at least one of 0 or 1.

10. The method according to claim 1, further comprising a step of training the neural network, which comprises:
acquiring a training sample and a real detection result for monitoring;
performing processing on the training sample by using the neural network to obtain a prediction result; and
feeding back and adjusting a network parameter of the neural network based on a loss corresponding to the prediction result and the real detection result, until a termination condition is satisfied, wherein the network parameter comprises the convolution kernel of each network layer and the transformation matrix.

11. An information processing apparatus, comprising:
a processor; and
a memory configured to store processor-executable instructions,
wherein the processor is configured to invoke the instructions stored in the memory, so as to:
input received input information to a neural network;
process the input information by means of the neural network, wherein in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and
output a processing result of the processing of the neural network.

12. The apparatus according to claim 11, wherein updating the convolution kernel of the convolution layer by using the transformation matrix configured for the convolution layer comprises:
acquiring a space dimension of the convolution kernel of the convolution layer;
executing duplication processing on the transformation matrix corresponding to the convolution layer based on the space dimension of the convolution kernel, wherein the number of times of duplication processing is determined by the space dimension of the convolution kernel; and
executing dot product processing on the transformation matrix after the duplication processing and the convolution kernel to obtain the updated convolution kernel of the corresponding convolution layer.

13. The apparatus according to claim 11, wherein before executing convolution processing by means of the convolution layer of the neural network, the processor is further configured to:
determine a matrix unit constituting the transformation matrix corresponding to the convolution layer, and form the transformation matrix of the convolution layer based on the determined matrix unit, wherein the matrix unit comprises a first matrix and a second matrix, or only comprises the second matrix, wherein in response to the number of channels of an input feature and the number of channels of an output feature of the convolution layer being different, the transformation matrix corresponding to the convolution layer comprises the first matrix and the second matrix; and in response to the number of channels of the input feature and the number of channels of the output feature of the convolution layer being identical, the transformation matrix corresponding to the convolution layer comprises the second matrix, wherein the first matrix is formed by connecting unit matrixes, and the second matrix is obtained by inner products of function transformations of a plurality of sub-matrixes.

14. The apparatus according to claim 13, wherein determining the second matrix constituting the transformation matrix of the convolution layer comprises:
acquiring a gate control parameter configured for each convolution layer;
determining the sub-matrixes constituting the second matrix based on the gate control parameter; and
forming the second matrix based on the determined sub-matrixes.

15. The apparatus according to claim 14, wherein acquiring the gate control parameter configured for each convolution layer comprises:
acquiring the gate control parameter configured for each convolution layer according to received configuration information; or
determining the gate control parameter configured for the convolution layer based on a training result of the neural network.

16. The apparatus according to claim 13, wherein forming the transformation matrix of the convolution layer based on the determined matrix unit comprises:
acquiring the number of first channels of the input feature and the number of second channels of the output feature of each convolution layer;
in response to the number of the first channels being greater than the number of the second channels, forming the transformation matrix as a product of the first matrix and the second matrix; and
in response to the number of the first channels being less than the number of the second channels, forming the transformation matrix as a product of the second matrix and the first matrix.

17. The apparatus according to claim 14, wherein determining the sub-matrixes constituting the second matrix based on the gate control parameter comprises:
performing function processing on the gate control parameter by using a sign function to obtain a binaryzation vector; and
obtaining a binaryzation gate control vector based on the binaryzation vector, and obtain the plurality of sub-matrixes based on the binaryzation gate control vector, a first basic matrix, and a second basic matrix, and
wherein obtaining the binaryzation gate control vector based on the binaryzation vector comprises:
determining the binaryzation vector as the binaryzation gate control vector; or
determining a product of a permutation matrix and the binaryzation vector as the binaryzation gate control vector.

18. The apparatus according to claim 17, wherein obtaining the plurality of sub-matrixes based on the binaryzation gate control vector, the first basic matrix, and the second basic matrix comprises:
obtaining a sub-matrix of an all-ones matrix in the case that an element in the binaryzation gate control vector is a first numerical value; and
obtaining a sub-matrix of the unit matrix in the case that the element in the binaryzation gate control vector is a second numerical value,
wherein the first basic matrix is the all-ones matrix, and the second basic matrix is the unit matrix.

19. The apparatus according to claim 11, wherein the processor is further configured to train the neural network, wherein training the neural network comprises:
acquiring a training sample and a real detection result for monitoring;
performing processing on the training sample by using the neural network to obtain a prediction result; and
feeding back and adjusting a network parameter of the neural network based on a loss corresponding to the prediction result and the real detection result, until a termination condition is satisfied, wherein the network parameter comprises the convolution kernel of each network layer and the transformation matrix.

20. A non-transitory computer-readable storage medium, having computer program instructions stored thereon, wherein when the computer program instructions are executed by a processor, the processor is caused to perform the operations of:
inputting received input information into the neural network;
processing the input information by means of the neural network, wherein in the case that convolution processing is executed by means of a convolution layer of the neural network, a convolution kernel of the convolution layer is updated by using a transformation matrix configured for the convolution layer, so that the convolution processing of the convolution layer is completed by means of the updated convolution kernel; and
outputting a processing result of the processing of the neural network.
